(19) United States
(12) Patent Application Publication
(10) Pub. No.: US 2015/0004052 A1
(43) Pub. Date: Jan. 1, 2015

(54) COPPER ALLOY AND COPPER ALLOY WIRE

(71) Applicants: Sumitomo Electric Industries, Ltd., Osaka-shi (JP); Sumitomo (SEI) Steel Wire Corp., Itami-shi (JP)

(72) Inventors: Hiromu Izumida, Itami-shi (JP); Kenichi Shimizu, Itami-shi (JP); Shinei Takamura, Itami-shi (JP)

(21) Appl. No.: 14/371,163

(22) PCT Filed: Dec. 28, 2012
(86) PCT No.: PCT/JP2012/084190

§ 371 Date: Jul. 8, 2014

(30) Foreign Application Priority Data
Jan. 11, 2012 (JP) 2012-003521

(51) Int. Cl. H01B 1/02

(52) U.S. Cl. CPC H01B 1/026; C22C 9/00
USPC 420/496

(57) ABSTRACT

A copper alloy having high strength and a high electrical conductivity in combination and a copper alloy wire are provided. A copper alloy contains 50 percent by mass or more and 95 percent by mass or less of Cu, 5 percent by mass or more and 50 percent by mass or less of Fe, and the remainder composed of deoxidizer elements and incidental impurities and has a texture exhibiting large diffraction peaks in the <111> orientation of Cu and in the <110> orientation of Fe when a cross-section is subjected to X-ray diffraction. The intensity ratio I_{Cu( 111)} of the diffraction peak in the <111> orientation of Cu to the intensity of the whole diffraction lines of Cu is 0.70 or more and 1.0 or less and the intensity ratio I_{Fe(110)} of the diffraction peak in the <110> orientation of Fe to the intensity of the whole diffraction lines of Fe is 0.90 or more and 1.0 or less. This copper alloy has a high electrical conductivity of 50% IACS or more in spite of high strength by controlling the orientation property in such a way that the above-described specific texture is established.

### TECHNICAL FIELD

The present invention relates to a copper alloy utilized as a contact member and the like and a copper alloy wire. In particular, the present invention relates to a copper alloy having high strength and a high electrical conductivity in combination.

### BACKGROUND ART

Examples of contact members utilized for electrical connection between an electric electronic apparatus and a wire, electrical connection between wires, and the like include contact portions (pins, housings having predetermined shapes, and the like) and terminal fittings of connectors and contact springs (compression springs, diagonal winding springs, leaf springs, and the like) which maintain the contact state by energizing forces. The contact member, e.g., a contact spring, is required to have a high electrical conductivity, a large spring load (energizing force of spring), and difficulty in relaxation of stress. In order to respond to the requirements, it is desirable that the electrical conductivity be high and the strength be high.

In order to satisfy the above-described requirements, copper alloys are prepared, where copper (Cu) having a high electrical conductivity serves as a base and various additive elements are contained. Patent literature 1 discloses a Cu—Fe alloy in which Fe is added as a primary additive element. The solid solubility of Fe in Cu is small, so that Fe is present in the Cu—Fe alloy while being dispersed in a parent phase. Therefore, in the case where a Cu—Fe alloy cast material is subjected to plastic forming, e.g., wire drawing or rolling, dispersed Fe is drawn into a fibrous shape. The strength of the Cu—Fe alloy is enhanced by this fibrous Fe, and a high electrical conductivity is exhibited on the basis of Cu serving as the primary component of the parent phase.

### CITATION LIST

### Patent Literature

PTL 1: Japanese Unexamined Patent Application Publication No. 05-287417

### SUMMARY OF INVENTION

### Technical Problem

It is desirable that the above-described contact member, e.g., a contact spring, have high electrical conductivity, the electrical conductivity satisfy preferably 50% IACS or more, and the strength be further enhanced.

An increase in the content of the additive element, that is, an increase in the concentration of the alloy, is effective for enhancement in the strength. However, there is a trade-off relationship between the strength and the electrical conductivity, and if the additive elements other than Cu increase, the characteristics of Cu serving as the base are lost and reduction in the electrical conductivity is caused (refer to the description 0019 in PTL 1 and the like). Consequently, although depending on the use, it is desirable that the above-described contact members have strength of 700 MPa or more and an electrical conductivity of 50% IACS or more, furthermore, strength of 750 MPa or more and an electrical conductivity of 50% IACS or more, and particularly strength of 900 MPa or more and an electrical conductivity of 50% IACS or more in combination.

Accordingly, one object of the present invention is to provide a copper alloy having high strength and a high electrical conductivity in combination. Also, another object of the present invention is to provide a copper alloy wire having high strength and a high electrical conductivity in combination.

### Solution to Problem

In development of a copper alloy having a high electrical conductivity and, in addition, high strength, the present inventors studied microstructure of an alloy, where the subject was the Cu—Fe alloy serving as a two-phase alloy in which two types of elements, Cu and Fe, were primary components and a Cu phase and a Fe phase were separated into two phases.

In general, Cu is mild and has high stacking fault energy, so that dislocation is not introduced easily and, as a result, a certain level or more of forming strain cannot be introduced. Therefore, there is a limit of increase in the strength of Cu even when the degree of plastic forming (cold forming), e.g., wire drawing or rolling, is increased. Then, in the Cu—Fe alloy, Fe is utilized as an element to enhance the strength. As the above-described degree of forming is increased, Fe can be drawn into a fibrous shape, and a strength enhancing effect by fiber reinforcement can be expected. However, along with an increase in the above-described degree of forming, Fe makes a solid solution with Cu in a minimal way, and reduction in the electrical conductivity is caused.

For example, in the case where plastic forming is applied over a plurality of passes, a heat treatment (aging at about 300° C. to 500° C.) is applied in the middle of forming and, thereby, a forming strain which has been introduced into a workpiece before the heat treatment can be brought into the state of zero. That is, the total degree of forming of passes between the heat treatments or the total degree of forming from the final heat treatment to the final dimension (wire diameter, thickness, cross-sectional area, and the like) can be decreased while the whole degree of forming is increased. As a result, it is considered that the solid solubility of Fe is reduced and reduction in the electrical conductivity can be suppressed. Meanwhile, when the Cu—Fe alloy is subjected to plastic forming (typically cold forming), Cu forms a texture in which mainly the <111> orientation is oriented and Fe forms a texture in which mainly the <110> orientation is oriented and, as described in Test examples later, the above-described heat treatment in the middle of forming does not have an influence on the texture which has been formed before the heat treatment concerned.

From the above-described findings, the present inventors noted the texture, and the orientation of each of Cu and Fe was adjusted by applying plastic forming (cold forming), e.g., wire drawing or rolling, and a heat treatment under various conditions to the workpiece made from the Cu—Fe alloy. As a result, it was found that in the case where each of Cu and Fe satisfied specific orientation property in the texture, a forming strain was applied to the Cu—Fe alloy effectively, the strength was able to be enhanced and, in addition, a high electrical conductivity was able to be maintained, i.e. a copper alloy having excellent strength and electrical conductivity in combination was obtained. Also, surprisingly, it was found that when a copper alloy having a texture satisfying the above-described specific orientation property was used as a workpiece and plastic forming was further applied after a heat treatment, even in the case where the degree of the plastic forming concerned was small (for example, about 50%), the same level of strength as the strength in the case of a large degree (for example, about 80%) was exhibited. In general, a forming strain is once canceled by the heat treatment, the strength is reduced, and the strength is enhanced by the forming after the heat treatment. As for the copper alloy having the texture satisfying the above-described specific orientation property, the degree of enhancement of the strength is large, and even in the case where forming is applied with a small degree of forming, a copper alloy having strength more than or equal to the strength before the heat treatment is obtained. More specifically, as for this copper alloy, when the correlation between the degree of forming and the strength before a predetermined heat treatment applied in the middle of the plastic forming (cold forming), e.g., wire drawing or rolling, (hereafter referred to as degree of forming-strength correlation (before)) and the correlation between the degree of forming and the strength after the predetermined heat treatment (hereafter referred to as degree of forming-strength correlation (after)) are determined, the inclination indicating the degree of forming-strength correlation (after) is larger than the inclination indicating the degree of forming-strength correlation (before). Also, a copper alloy having a higher electrical conductivity is obtained because the degree of forming is small. The present invention is on the basis of the above-described findings.

A copper alloy according to the present invention is a Cu-Fe alloy containing 50 percent by mass or more and 95 percent by mass or less of Cu, 5 percent by mass or more and 50 percent by mass or less of Fe, and the remainder composed of deoxidizer elements and incidental impurities. The copper alloy according to the present invention has a texture with the I_{Cu(111)} of 0.70 or more and 1.0 or less and the I_{Fe(110)} of 0.90 or more and 1.0 or less where a cross-section is subjected to X-ray diffraction. The above-described I_{Cu(111)} is specified to be the intensity ratio of the diffraction peak in the <111> orientation of Cu to the intensity of the whole diffraction lines of Cu and the above-described I_{Fe(110)} is specified to be the intensity ratio of the diffraction peak in the <110> orientation of Fe to the intensity of the whole diffraction lines of Fe.

The copper alloy according to the present invention has a texture in which both Cu and Fe satisfy the specific orientation properties and, therefore, has high strength and an excellent electrical conductivity and satisfies the tensile strength of 700 MPa or more and the electrical conductivity of 50% IACS or more.

As one aspect of the present invention, an aspect in which the above-described I_{Cu(111)} is 0.75 or more or an aspect in which the above-described I_{Cu(111)} is 0.90 or more is mentioned.

In the above-described aspect in which the above-described intensity ratio of the diffraction peak I_{Cu(111)} is larger, the strength is further excellent. For example, in some cases, the copper alloys with the I_{Cu(111)}≧0.75 according to the present invention satisfy the tensile strength of 750 MPa or more and the electrical conductivity of 50% IACS or more and in some cases, the copper alloys with the I_{Cu(111)}≧0.90 according to the present invention satisfy the tensile strength of 900 MPa or more and the electrical conductivity of 50% IACS or more.

As one aspect of the present invention, an aspect in which the tensile strength of the copper alloy concerned is 900 MPa or more and, in addition, the electrical conductivity of the above-described copper alloy is 50% IACS or more is mentioned.

In the above-described aspects, high electrical conductivity is exhibited and, in addition, the strength is further excellent.

The copper alloy according to the present invention takes various forms on the basis of plastic forming. For example, in the case where drawing (wire drawing) is performed as the plastic forming, a wire rod made from the copper alloy according to the present invention (copper alloy wire according to the present invention) can be produced. The copper alloy wire according to the present invention has high strength and a high electrical conductivity and, therefore, can be favorably utilized as, for example, a workpiece for a contact spring. This contact spring is formed from a high-strength workpiece (wire rod having the texture satisfying the above-described specific orientation property), so that a predetermined spring load can be given over the long term and, in addition, a stress is not relaxed easily.

### Advantageous Effects of Invention

The copper alloy and the copper alloy wire according to the present invention have high strength and an excellent electrical conductivity.

### DESCRIPTION OF EMBODIMENTS

The present invention will be described below in more detail. In this regard, in the explanations hereafter, all contents of the “composition” are “mass proportions”.

[Copper Alloy]

(Composition)

A copper alloy according to the present invention is a binary alloy in which the base is Cu and a primary additive element is Fe, the Cu content is specified to be 50% or more and 95% or less, and the Fe content is specified to be 5% or more and 50% or less. The electrical conductivity is high because the Cu content is 50% or more, and the strength is high because the Fe content is 5% or more. As the Cu content increases, the electrical conductivity is high, and as the Fe content increases, the strength is high. More preferably, the Fe content is 5% or more and 30% or less, and in particular, 10% or more and 20% or less.

In the copper alloy according to the present invention, the remainder other than Cu and Fe are specified to be deoxidizer elements and incidental impurities. Examples of deoxidizer elements include Mn, Al, Si, and P. The deoxidizer elements are residues of the deoxidizer added in production, and a permissible content is about 5% or less in total. Examples of incidental impurities include constituent components of a production facilities (crucible, dice, rolling roller, and the like) and lubricants used in the production.

(Texture)

The copper alloy according to the present invention has a texture in which each of Cu and Fe is oriented in a specific orientation. Specifically, Cu is oriented in the <111> orientation and Fe is oriented in the <110> orientation. Then, Cu satisfies the above-described intensity ratio I_{Cu(111)} of the diffraction peak of 0.70 or more and Fe satisfies the above-described intensity ratio I_{Fe(110)} of the diffraction peak of 0.90 or more. As for both Cu and Fe, the strength tends to become high as the orientation property becomes high (the above-described intensity ratio of the diffraction peak becomes large), preferably the I_{Cu(111)} is 0.75 or more, furthermore 0.85 or more, and in particular 0.90 or more, and preferably the I_{Fe(110)} is 0.92 or more, furthermore 0.95 or more, and in particular 0.98 or more. The I_{Cu(111)} and the I_{Fe(110)} depend on mainly the degree of forming and tend to become large as the degree of forming becomes high. However, in the case where a workpiece having a texture satisfying the I_{Cu(111)}≧0.70 and the I_{Fe(110)}≧0.90 is subjected to a heat treatment and is further subjected to plastic forming, the I_{Cu(111)} and the I_{Fe(110)} of the copper alloy subjected to forming at a small degree of forming (for example, about 50%) and the I_{Cu(111)} and the I_{Fe(110)} of the copper alloy subjected to forming at a large degree of forming (for example, about 80%) become the same level.

In this regard, the diffraction peak is examined by taking a cross-section of the copper alloy according to the present invention and subjecting the cross-section to X-ray diffraction. In the case where the copper alloy according to the present invention is a wire rod or a sheet, a cross-section (transverse section) orthogonal to the forming direction (drawing direction, rolling direction, or the like and typically a longitudinal direction) is subjected to the X-ray diffraction.

(Form)

The copper alloy according to the present invention takes various forms depending on the types of the plastic forming. Typical examples include a wire rod (copper alloy wire in the present invention) in the case where drawing is applied and a sheet, a belt (relatively long), a strip (relatively long), and foil (thickness is relatively small) in the case where rolling is applied.

The wire rods have various cross-sectional shapes depending on the shape of a wire drawing dice or a wire drawing roller, and circular cross-sections (circular wires) and rectangular cross-sections (rectangular wires) are typically mentioned. In addition, odd-form wire rods and the like having elliptical cross-sections, polygonal cross-sections, and the like are mentioned.

The sheets are cut into predetermined shapes and, therefore, have various shapes when viewed in plan. In general, the shape before cutting is rectangular.

(Size)

The diameter (cross-sectional area) of the above-described wire rod and thickness·width and the length of the above-described sheet do not much matter. The degree of forming may be selected or cutting into a predetermined length may be performed in such a way that a predetermined size (diameter, thickness, and the like) is ensured in accordance with the use and the size does not much matter. For example, a circular wire having a circular cross-section with a diameter of 0.1 mm or more and 1.2 mm or less and a sheet or a belt with a thickness of 0.1 mm or more and 0.5 mm or less are mentioned.

(Strength)

The copper alloy according to the present invention is formed from the above-described specific texture and has high tensile strength satisfying 700 MPa or more. As the tensile strength becomes high, considerable effects are obtained. For example, miniaturization·weight reduction can be performed, a spring load can be increased, a large spring load is maintained easily, stress relaxation property is excellent, and fracture does not occur easily. Therefore, preferably, the tensile strength is 750 MPa or more, furthermore 800 MPa or more, and in particular 900 MPa or more. In general, the tensile strength depends on the orientation property, and the tensile strength tends to become large as the orientation properties of both Cu and Fe (intensity ratios I_{Cu(111)} and I_{Fe(110)} become high.

The copper alloy according to the present invention has a high electrical conductivity satisfying 50% IACS or more. The forms in which the electrical conductivity is 55% IACS or more or 60% IACS or more are mentioned depending on the composition and the degree of forming.

[Manufacturing Method]

The copper alloy according to the present invention can be produced typically through the steps of melting→casting→cold forming (appropriate heat treatment). Examples of cold forming include drawing (wire drawing) by using a wire drawing dice or a wire drawing roller and rolling by using a rolling roller. The size of the workpiece subjected to the cold forming can be appropriately selected in consideration of the whole degree of forming (degree of forming=reduction in area in the case of drawing, degree of forming=reduction ratio in the case of rolling) until final dimensions are obtained by applying the cold forming concerned.

It is preferable that a heat treatment be applied before the cold forming or in the middle of the cold forming. The heat treatment before or in the middle of the cold forming is specified to be an aging treatment, where Fe is isolated positively and the toughness and the electrical conductivity are recovered. Also, the heat treatment in the middle of forming can remove forming stress introduced into the alloy excessively. As for this heat treatment condition, a heating temperature of 300° C. or higher and 500° C. or lower and a holding time of 1 minute or more and 3 hours or less (appropriately selected in accordance with the shape) are mentioned. If the heating temperature of this heat treatment is lower than 300° C., isolation of Fe becomes insufficient and, in addition, the above-described forming stress cannot be removed sufficiently. If the above-described heating temperature is higher than 500° C., copper oxide is formed considerably, discoloration occurs and, in addition, defective deformation occurs in the forming and the electrical conductivity of the product is reduced easily. In particular, it is preferable that this heat treatment be applied when the final dimensions are approached, that is, the plastic forming after the heat treatment concerned is specified to be the final forming and the heat treatment is applied in such a way as to reduce the degree of forming of this final forming. As the degree of forming of the final forming is small, the electrical conductivity is increased easily. It is preferable that the timing of performing the above-described heat treatment be selected in such a way that the degree of forming of the final forming becomes about 60% or more and 80% or less.

The copper alloy according to the present invention will be described below with reference to test examples. In all the tests described below, a workpiece made from Cu—Fe alloy was subjected to a heat treatment and, thereafter, plastic forming was applied, so that a plastic formed material was produced. As for the resulting plastic formed material, the orientation properties of Cu and Fe, the tensile strength (MPa), and the electrical conductivity (% IACS) were examined.

### TEST EXAMPLE 1

In Test example 1, the degree of forming of the plastic forming was changed and copper alloys having different final wire diameters were produced.

Raw materials were prepared in such a way that Cu—Fe alloys having the compositions shown in Table I were obtained, melting and casting were performed, and the resulting cast materials were subjected to cold rolling, so that rolled wire rods having a diameter φ of 5.0 mm were produced as workpieces. In the casting, Mn was used as a deoxidizer. The prepared workpieces were subjected to a heat treatment of 450° C.×3 hours, so that forming strains introduced by plastic forming (here, cold rolling) before the heat treatment concerned were allowed to become zero (degree of forming 0%).

The workpieces after the above-described heat treatment were subjected to drawing at degrees of forming (reduction in area, %) shown in Table I by using the wire drawing dice, so that a plurality of wire rods were produced at different degrees of forming.

A cross-section (transverse section) perpendicular to the drawing direction was taken from the resulting wire rod of each of samples, and orientation properties of primary components, Cu and Fe, were examined by the X-ray diffraction XRD. The measurement conditions were as described below.

Apparatus employed SmartLab-2D-PILATUS (Rigaku Corporation)

X-ray employed Cu—Kα

Excitation condition 45 kV, 200 mA

Collimator employed φ 0 3 mm

Measurement method θ-2θ method

In this test, X-ray diffraction was performed on a sample basis, where the center portion in the vicinity of the center of the transverse section was specified to be a measurement surface. The intensity I_{Cu}total of the whole diffraction lines of Cu in the measurement surface and the diffraction peak I_{Cu(111)}peek of the <111> orientation of Cu were determined, and the intensity ratio I_{Cu(111)}peek/I_{Cu}total=I_{Cu(111)} of the diffraction peak I_{Cu(111)}peek of the <111> orientation to the intensity I_{Cu}total of the whole diffraction lines was determined. Also, the intensity I_{Fe}total of the whole diffraction lines of Fe in the measurement surface and the diffraction peak I_{Fe(110)}peek of the <110> orientation of Fe were determined, and the intensity ratio I_{Fe(110)}peek/I_{Fe}total=I_{Fe(110)} of the diffraction peak I_{Fe(110)}peek of the <110> orientation to the intensity I_{Fe}total of the whole diffraction lines was determined Table I shows the I_{Cu(111)} and the I_{Fe(110)} in the above-described center portion of each sample. In this regard, in the case where the wire diameter of the sample was large, in the above-described transverse section, an average value of the diffraction peak in the vicinity of the surface of the sample (the point at a distance of about 50 μm from the surface toward the center) and the diffraction peak of the above-described center portion can be utilized as the I_{Cu(111)} and the I_{Fe(110)}. In the case where the sample is a thin wire rod, as in the present example, the measurement is performed easily by specifying the center portion to be the measurement surface, as described above.

The tensile strength of the resulting wire rod of each of the samples was measured on the basis of the specification of JIS Z 2241 (2011), and the electrical conductivity was calculated from the electric resistance measured by a four probe method. The results thereof are shown in Table I.

TABLE I

| | | Final wire | | | | Tensile | Electrical |
|---|---|---|---|---|---|---|---|
| Composition | Sample | diameter | Degree of | | | strength | conductivity |
| (percent by mass) | No. | (mm) | forming | I_{Cu(111)} | I_{Fe(110)} | (MPa) | (% IACS) |
| Cu: 80% | 1-1 | 3.54 | 50% | 0.57 | 0.81 | 625 | 53 |
| Fe: 20% | 1-2 | 2.74 | 70% | 0.68 | 0.86 | 672 | 54 |
| | 1-3 | 2.24 | 80% | 0.72 | 0.90 | 734 | 52 |
| | 1-4 | 1.58 | 90% | 0.81 | 0.92 | 794 | 51 |
| | 1-5 | 0.87 | 97% | 0.85 | 0.96 | 871 | 51 |
| | 1-6 | 0.50 | 99% | 0.96 | 0.99 | 1008 | 50 |
| Cu: 85% | 1-11 | 3.54 | 50% | 0.58 | 0.78 | 603 | 58 |
| Fe: 15% | 1-12 | 2.74 | 70% | 0.65 | 0.85 | 651 | 56 |
| | 1-13 | 2.24 | 80% | 0.71 | 0.92 | 711 | 57 |
| | 1-14 | 1.58 | 90% | 0.79 | 0.93 | 781 | 56 |
| | 1-15 | 0.87 | 97% | 0.84 | 0.96 | 858 | 55 |
| | 1-16 | 0.50 | 99% | 0.95 | 0.99 | 974 | 54 |
| Cu: 90% | 1-21 | 3.54 | 50% | 0.56 | 0.76 | 625 | 65 |
| Fe: 10% | 1-22 | 2.74 | 70% | 0.66 | 0.83 | 672 | 65 |
| | 1-23 | 2.24 | 80% | 0.74 | 0.91 | 707 | 63 |
| | 1-24 | 1.58 | 90% | 0.82 | 0.93 | 765 | 62 |
| | 1-25 | 0.87 | 97% | 0.84 | 0.95 | 815 | 62 |
| | 1-26 | 0.50 | 99% | 0.93 | 0.98 | 947 | 59 |

As is clear from Table I, the copper alloy having a texture satisfying the I_{Cu(111)} of 0.70 or more and the I_{Fe(110)} of 0.90 or more has high strength and, in addition, a high electrical conductivity, specifically the tensile strength is 700 MPa or more and the electrical conductivity is 50% IACS or more. Also, it is clear that the strength is enhanced as the I_{Cu(111)} and the I_{Fe(110)} increase. In this test, the tensile strength is 750 MPa or more when the I_{Cu(111)}≧0.75, the tensile strength is 800 MPa or more when the I_{Cu(111)}≧0.85, and the tensile strength is 900 MPa or more when the I_{Cu(111)}≧0.90. Furthermore, it is clear that as the Fe content increases, the strength is high and as the Cu content increases, the electrical conductivity is high. Therefore, it was ascertained that the copper alloy having a texture containing a specific range of Fe and satisfying the I_{Cu(111)}≧0.70 and, in addition, the I_{Fe(110)}≧0.90 had high strength and a high electrical conductivity in combination.

### TEST EXAMPLE 2

In Test example 2, a heat treatment was applied in the middle of the plastic forming appropriately, and copper alloys having the same final wire diameter were produced.

Specifically, workpieces prepared in Test example 1 (diameter φ 5.0 mm) were subjected to a heat treatment (450° C.×3 hours) and, thereafter, drawing was applied as with Test example 1. In the middle of the drawing, when “heat treatment wire diameter (mm)” shown in Table II was reached, a heat treatment of 450° C.×10 minutes was applied. Subsequently, drawing was further applied, so that wire rods having the final wire diameter (mm) shown in Table II were produced. The orientation properties (I_{Cu(111)}, I_{Fe(110)}), the tensile strength (MPa), and the electrical conductivity (% IACS) of the resulting wire rod of each of samples were examined in the same manner as that in Test example 1. The results thereof are shown in Table II.

TABLE II

| Composition | | Final wire | | Heat treatment | | | Tensile | Electrical |
|---|---|---|---|---|---|---|---|---|
| (percent | Sample | diameter | Degree of | wire diameter | | | strength | conductivity |
| by mass) | No. | (mm) | forming | (mm) | I_{Cu(111)} | I_{Fe(110)} | (MPa) | (% IACS) |
| Cu: 80% | 2-1 | 2.24 | 50% | 3.17 | 0.71 | 0.91 | 732 | 55 |
| Fe: 20% | 2-2 | 2.24 | 70% | 4.09 | 0.73 | 0.92 | 732 | 53 |
| | 2-3 | 2.24 | 80% | 5.00 | 0.72 | 0.90 | 734 | 52 |
| Cu: 85% | 2-11 | 2.24 | 50% | 3.17 | 0.71 | 0.92 | 710 | 58 |
| Fe: 15% | 2-12 | 2.24 | 70% | 4.09 | 0.70 | 0.91 | 709 | 59 |
| | 2-13 | 2.24 | 80% | 5.00 | 0.71 | 0.92 | 711 | 57 |
| Cu: 90% | 2-21 | 2.24 | 50% | 3.17 | 0.72 | 0.92 | 702 | 65 |
| Fe: 10% | 2-22 | 2.24 | 70% | 4.09 | 0.74 | 0.93 | 703 | 65 |
| | 2-23 | 2.24 | 80% | 5.00 | 0.74 | 0.91 | 707 | 63 |

As is clear from Table II, in the case where the heat treatment was performed in the middle of the cold forming as well, the copper alloy having a texture satisfying the I_{Cu(111)} of 0.70 or more and the I_{Fe(110)} of 0.90 or more has high strength and, in addition, a high electrical conductivity, specifically the tensile strength is 700 MPa or more and the electrical conductivity is 50% IACS or more. Then, in this test, the case where the degree of forming is low (here, the case where the degree of forming is 50%) and the case where the degree of forming is high (here, the degree of forming is 80%) are compared while the compositions are the same, and it is clear that the I_{Cu(111)} and the I_{Fe(110)} are the same level and the tensile strengths are the same level.

Consequently, it can be said that the orientation property of a texture having a certain orientation property (here, a texture in which the <111> orientation of Cu and the <110> orientation of Fe are predominantly oriented) does not collapse significantly even when the heat treatment is performed in the middle of the plastic forming. That is, this test result can be said to support that in a Cu—Fe alloy serving as a binary alloy, if a texture having a certain orientation property is formed once, the orientation property is enhanced by the plastic forming thereafter, the strength can be enhanced and, in addition, a high electrical conductivity can be maintained. Also, as is clear from this test result, even in the case where a heat treatment is applied in the middle of the plastic forming and a state in which the forming strain is once made zero and the strength is reduced is brought about, the degree of increase in strength due to forming after the heat treatment is large. This can be said to support that in the case where a copper alloy having the same final wire diameter is produced, the degree of final forming can be reduced by performing a heat treatment when the final wire diameter is approached. Although the degree of final forming is small, the strength is sufficiently high (in this test, the same level of strength as the strength in the case where the degree of final forming is high is exhibited), and the degree of forming concerned is small, so that the electrical conductivity is higher.

### TEST EXAMPLE 3

In Test example 3, a heat treatment was applied in the middle of the plastic forming appropriately, and copper alloys having the same final wire diameter were produced in the same manner as that in Test example 2. However, in Test example 3, the final wire diameter was made smaller than that in Test example 2, and the timing of application of the heat treatment was changed. Wire rods made from the Cu—Fe alloy were produced in the same manner as that in Test example 2 except the above-described point, and the orientation properties (I_{Cu(111)}, I_{Fe(110)}), the tensile strength (MPa), and the electrical conductivity (% IACS) were examined in the same manner as that in Test example 1. The results thereof are shown in Table III.

TABLE III

| Composition | | Final wire | | Heat treatment | | | Tensile | Electrical |
|---|---|---|---|---|---|---|---|---|
| (percent | Sample | diameter | Degree of | wire diameter | | | strength | conductivity |
| by mass) | No. | (mm) | forming | (mm) | I_{Cu(111)} | I_{Fe(110)} | (MPa) | (% IACS) |
| Cu: 80% | 3-1 | 0.5 | 50% | 0.71 | 0.95 | 0.99 | 1004 | 53 |
| Fe: 20% | 3-2 | 0.5 | 70% | 0.91 | 0.96 | 0.99 | 1003 | 52 |
| | 3-3 | 0.5 | 80% | 1.12 | 0.95 | 0.99 | 1007 | 52 |
| Cu: 85% | 3-11 | 0.5 | 50% | 0.71 | 0.94 | 0.98 | 970 | 56 |
| Fe: 15% | 3-12 | 0.5 | 70% | 0.91 | 0.95 | 0.99 | 974 | 58 |
| | 3-13 | 0.5 | 80% | 1.12 | 0.95 | 0.99 | 975 | 57 |
| Cu: 90% | 3-21 | 0.5 | 50% | 0.71 | 0.92 | 0.99 | 944 | 64 |
| Fe: 10% | 3-22 | 0.5 | 70% | 0.91 | 0.94 | 0.98 | 943 | 63 |
| | 3-23 | 0.5 | 80% | 1.12 | 0.93 | 0.99 | 946 | 64 |

As is clear from Test example 3, as with Test example 2, in the case where the heat treatment is performed in the middle of the cold forming as well, the copper alloy having a texture satisfying the I_{Cu(111)} of 0.70 or more and the I_{Fe(110)} of 0.90 or more has high strength and, in addition, a high electrical conductivity. Also, for example, a workpiece subjected to the above-described heat treatment in Sample No. 3-3 is formed at a degree larger than that of Sample No. 1-4 (sample having a final wire diameter of 1.58 mm) having the same composition in Table I in Test example 1 and has a smaller wire diameter (heat treatment wire diameter becomes 1.12 mm) and, therefore, it can be said that the workpiece concerned has a texture satisfying the I_{Cu(111)} of 0.70 or more and the I_{Fe(110)} of 0.90 or more. Likewise, when comparisons are made where the composition is the same, the workpiece subjected to the above-described heat treatment in Test example 3 is formed at a degree larger than those of Sample No. 1-5, No. 1-14, No. 1-15, No. 1-24, and No. 1-25 in Table I in Test example 1 and, therefore, it can be said that the workpiece concerned has a texture satisfying the I_{Cu(111)} of 0.70 or more and the I_{Fe(110)} of 0.90 or more. Then, it is clear that the orientation property can be further enhanced by using the copper alloy having such a specific texture as a workpiece and further applying a heat treatment and plastic forming. Specifically, as shown in Table III, it is clear that the texture satisfying the I_{Cu(111)} of 0.90 or more and the I_{Fe(110)} of 0.98 or more is provided, the tensile strength is 900 MPa or more, and the electrical conductivity is 50% IACS or more. Therefore, it is clear that the strength can be further enhanced by providing the texture satisfying the above-described specific orientation property.

[Advantages]

As is shown by the above-described test results, the copper alloy having a texture in which both Cu and Fe satisfy specific orientation properties has high strength and a high electrical conductivity in combination. Specifically, this copper alloy satisfies the tensile strength of 700 MPa or more and, in addition, the electrical conductivity of 50% IACS or more. Therefore, in the case where this copper alloy is utilized for the use, e.g., a contact spring, desired to have high strength in addition to a high electrical conductivity, a predetermined spring load can be given over the long term and a stress is not relaxed easily, so that sufficient conduction can be expected. Also, in production of the copper alloy having the above-described specific texture, a heat treatment is applied in the middle of the cold forming, in particular, when the final wire diameter is approached, so that the electrical conductivity can be further increased while high strength at the same level as the level of the strength in the case where a heat treatment is applied in the upstream to the cold forming is exhibited.

In this regard, the present invention is not limited to the above-described embodiments, and appropriate modifications can be added within the bounds of not departing from the gist of the present invention. For example, the composition (Fe content), the heat treatment condition (timing of application, temperature, time, and the like), the degree of plastic forming (cold forming), and the form of the copper alloy (rolled sheet and the like) can be changed.

### INDUSTRIAL APPLICABILITY

The copper alloy according to the present invention can be favorably utilized for workpieces of members (connector female portions, connector contact portions, terminal fittings, contact springs, switches, sockets, relays, and the like) to electrically connecting between various electric electronic apparatuses e.g., storage batteries, generators, and car-mounted parts, and wires and between wires, and other workpieces of electrically conductive members required to have high strength and a high electrical conductivity. The copper alloy wire according to the present invention can be favorably utilized as workpieces for contact springs, e.g., compression springs and diagonal winding springs.

1. A copper alloy, comprising:
a composition being 50 percent by mass or more and 95 percent by mass or less of Cu, 5 percent by mass or more and 50 percent by mass or less of Fe, and the remainder composed of deoxidizer elements and incidental impurities; and
a texture having the I_{Cu(111)} of 0.70 or more and 1.0 or less and the I_{Fe(110)} of 0.90 or more and 1.0 or less
where the I_{Cu(111)} represents the intensity ratio of the diffraction peak in the <111> orientation of Cu to the intensity of the whole diffraction lines of Cu and
the I_{Fe(110)} represents the intensity ratio of the diffraction peak in the <110> orientation of Fe to the intensity of the whole diffraction lines of Fe, when a cross-section is subjected to X-ray diffraction.

2. The copper alloy according to claim 1, wherein the I_{Cu(111)} is 0.75 or more.

3. The copper alloy according to claim 1 or claim 2, wherein the I_{Cu(111)} is 0.90 or more.

4. The copper alloy according to claim 3, wherein the tensile strength of the copper alloy is 900 MPa or more, and the electrical conductivity of the copper alloy is 50% IACS or more.

5. A copper alloy wire made from the copper alloy according to claim 1.
